(19) United States
(12) Patent Application Publication
(10) Pub. No.: US 2004/0114069 A1
(43) Pub. Date: Jun. 17, 2004

(54) Backlight system and liquid crystal display using the same

(76) Inventor: Chuan De Lai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/661,736

(22) Filed: Sep. 11, 2003

(30) Foreign Application Priority Data
Dec. 17, 2002 (TW) 91220456

(51) Int. Cl. G02F 1/1335

(52) U.S. Cl. 349/65

(57) ABSTRACT

A backlight system (10) includes a light guide plate (12) having a plurality of incident surfaces (124) disposed at corners thereof, a light exit surface (121), and a bottom surface (123) opposite to the light exit surface; and a plurality of point light sources (11) for emitting light beams and disposed adjacent and opposite to the incident surfaces. The bottom surface includes a scattering pattern (14) having a plurality of dots thereon, and a covering rate of the scattering pattern varies to promote a uniform light distribution density of the light beams emitted from the light guide plate.

### BACKGROUND OF THE INVENTION

1. Field of the Invention

The present invention relates to a surface light source device and particularly to a backlight system for a liquid crystal display or the like.

2. Description of Related Art

A liquid crystal display device includes, for example, a liquid crystal panel and a backlight system mounted under the liquid crystal panel for supplying light beams thereto. The backlight system mainly comprises a light source and a light guide plate, wherein the light guide plate is made of a transparent acrylic plastic and is used for guiding the light beams emitted by the light source to uniformly illuminate the liquid crystal display panel.

The light source emits light beams into the light guide plate, wherein the light beams are totally internally reflected. In order to diffuse the light beams and emit them uniformly from a top surface of the light guide plate, protrusions or recesses are disposed on a bottom surface of the light guide plate, or a diffusion dot-pattern is formed on the bottom surface of the light guide plate.

Referring to FIG. 7, a conventional backlight system includes a light guide plate 3, two light emitting diodes (LED) 1 arranged adjacent to two opposite sides of the light guide plate 3, respectively, and a reflective sheet (not shown). The light guide plate 3 has a dot-pattern on a bottom surface (not shown) thereof, and the reflective sheet is arranged adjacent to the bottom surface of the light guide plate 3.

Light beams from the light emitting diodes 1 enter into the light guide plate 3, and then are transmitted out from a light output surface (not labeled) of the light guide plate 3 to illuminate an LCD panel.

However, the conventional backlight system has a disadvantage. Each LED emits light beams within a certain emitting angle, thus, light beams are unevenly distributed in the light guide plate. Particularly, corners 2 of the light guide plate 3 have lower light distribution density.

Therefore, an improved backlight system which overcomes the above-described disadvantages of the conventional backlight system is desired.

### SUMMARY OF THE INVENTION

An object of the present invention is to provide a backlight system which emits light with a high degree of uniformity.

In order to achieve the above-described object, a backlight system in accordance with the present invention includes a light guide plate having a plurality of incident surfaces disposed at corners thereof, a light exit surface, and a bottom surface opposite to the light exit surface; and a plurality of point light sources for emitting light beams, the point light sources being disposed adjacent to the incident surfaces. The bottom surface includes a scattering pattern having a plurality of dots thereon, and a covering rate of the scattering pattern varies to promote a uniform emitted light distribution density over the light guide plate.

Other objects, advantages, and novel features of the present invention will become more apparent from the following detailed description when taken in conjunction with the accompanying drawings, wherein:

### BRIEF DESCRIPTION OF THE DRAWINGS

FIG. 1 is a perspective view of a backlight system of a first embodiment in accordance with the present invention;

FIG. 2 is an essential optical paths diagram of light beams emitted into a light guide plate of the backlight system of FIG. 1, viewed from a top aspect;

FIG. 3 is a schematic view of a light guide plate of the backlight system in FIG. 1, viewed from a bottom aspect;

FIG. 4 is an essential optical paths diagram of light beams emitted into a light guide plate of a backlight system of a second embodiment according to the present invention, viewed from a top aspect;

FIG. 5 is a schematic view of a light guide plate of the backlight system in FIG. 4, viewed from a bottom aspect;

FIG. 6 is a schematic diagram of an LCD device employing the backlight system of FIG. 1, according to the present invention; and

FIG. 7 is a prior art backlight system.

### DETAILED DESCRIPTION OF THE PRESENT INVENTION

Reference now will be made to the drawings to describe the present invention in detail.

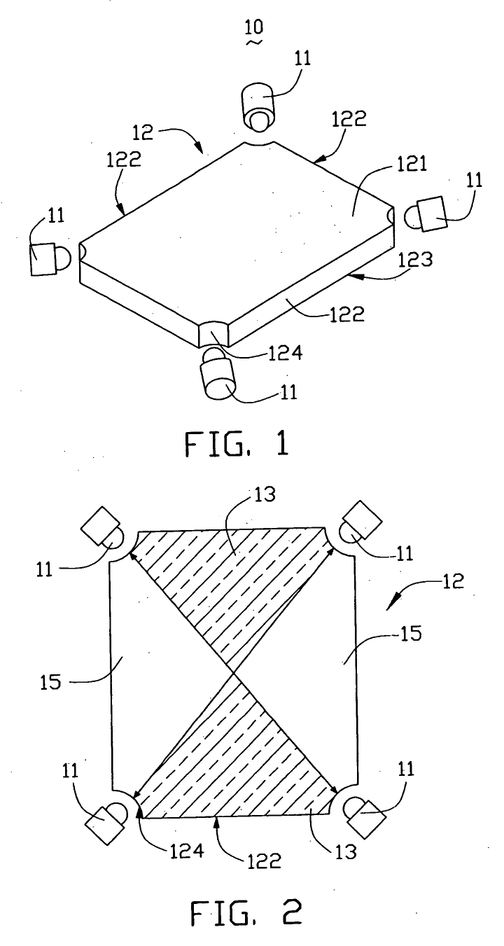

Referring to FIG. 1, a backlight system 10 of a first embodiment in accordance with the present invention comprises a light guide plate 12 and a plurality of point light sources 11. The light guide plate 12 is rectangular in shape, and comprises four incident surfaces 124 at four corners of the light guide plate 12, a light exit surface 121, a bottom surface 123 opposite to the exit surface 121, and four side surfaces 122. The light exit surface 121 is perpendicular to the incident surfaces 124 and the side surfaces 122.

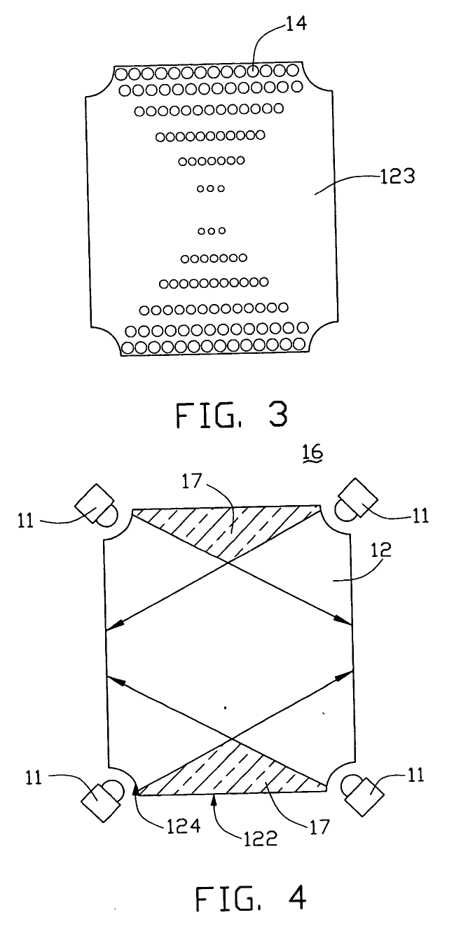

Referring to FIG. 2, an essential optical paths diagram of light beams emitted into the light guide plate 12 of the backlight system 10 in FIG. 1 is shown, viewed from a top aspect. Each point light source 11 is disposed adjacent and opposite to one incident surface 124 of the light guide plate 12, respectively. The point light sources 11 may be light emitting diodes (LEDs), each having an emitting angle of about 30°, or the like. Therefore, when light beams propagate into the light guide plate 12, there is a lower light intensity distribution in an area 13 in the light guide plate 12, in which less light exists and from which less light is emitted.

Referring to FIG. 3, the bottom surface 123 has a scattering pattern 14 thereon, corresponding to the lower light intensity distributing area 13, which scattering pattern 14 diffuses light beams incident thereon to make the light intensity emitted from said lower light distributing area 13 more homogenious with other areas of the light guide plate 12. The scattering pattern 14 comprises a plurality of dots (not labeled), whose covering rate is determined by the light intensity distribution, therefore, the covering rate is denser the farther away from the emitting angle, and less dense in the vicinity of the emitting angle. This arrangement promotes a more uniform emission of light beams from the light exit surface 121. The dots can be formed in hemispherical, cylindrical, rectangular, cuboidal, or other shape.

The bottom surface 123 further comprises a reflective film (not shown) for reflecting the light beams upwardly to the light exit surface 121. The reflective film should have a reflectivity of greater than 98% for wavelengths in a visible range of the spectrum. The reflective film comprises a plurality of layers of materials having a high reflectivity.

In operation, light beams emitted by each point light source 11 enter into the light guide plate 12 through the corresponding light incident surface 124. The reflective film reflects light beams upwardly to the light exit surface 121. Furthermore, a portion of the light beams are diffused by the dots of the scattering pattern 14 on the bottom surface 123, which improves the light emission from the area 13. Subsequently, light beams are transmitted out from the light exit surface uniformly.

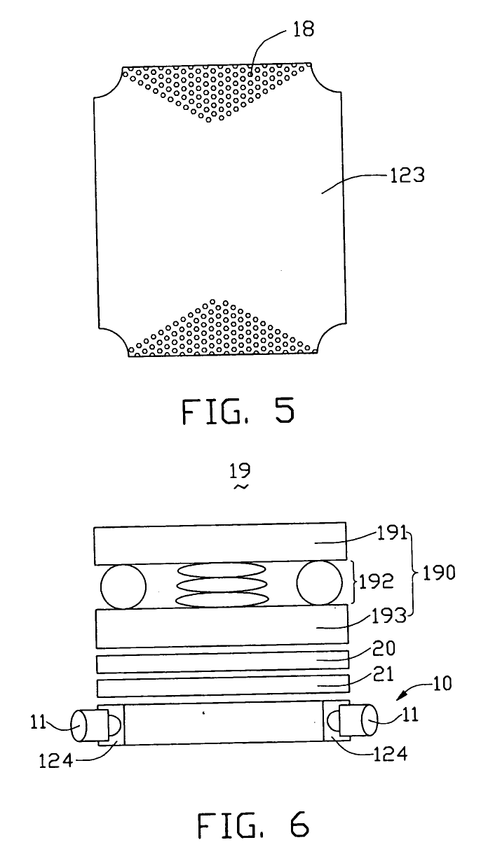

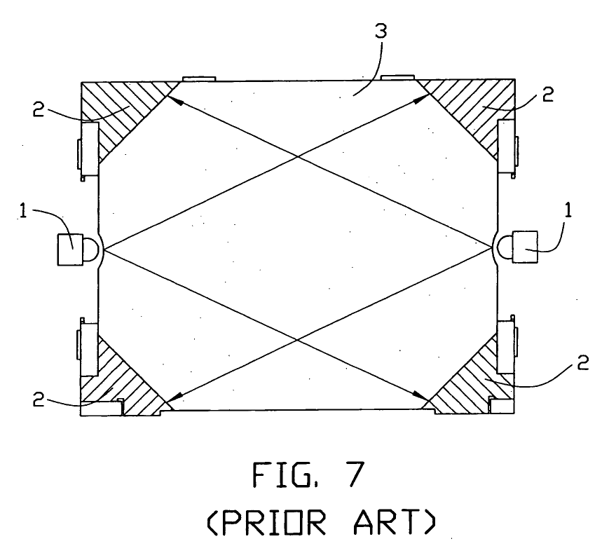

Referring to FIGS. 4-5, a backlight system 16 of a second embodiment of the present invention is similar to the backlight system 10 of the first embodiment. However, the point light sources 11 may be light emitting diodes (LEDs) with an emitting angle of about 60°, or the like. Therefore, when light beams propagate into the light guide plate 12, there is also a lower light intensity distribution in an area 17 in the light guide plate 12, in which less light exists, just like the area 13 in the light guide plate 10. The bottom surface 123 has a scattering pattern 18 thereon, corresponding to the lower light intensity distributing area 17, which diffuses light beams to promote more homogenious emission of the light from the light guide plate 12.

FIG. 6 shows an LCD device 19 employing the backlight system 10. The LCD device 19 comprises the backlight system 10, a diffusion sheet 21, a prism sheet 20, a second substrate 193, a liquid crystal layer 192 and a first substrate 191, which are arranged in order. The backlight system 10 comprises a plurality of point light sources 11 and a light guide plate 12. In operation, light beams emitted by the point light sources 11 enter into the light guide plate 12, then are transmitted out from the light exit surface 121 uniformly, subsequently passing through the diffusion sheet 21 and the prism sheet 20 to illuminate the liquid crystal panel 190, successively.

In order to improve the brightness of the light guide plate 12, the dots may also be disposed on the area 15 (shown in FIG. 2), and the shape of the light guide plate 12 can be wedge-shaped.

An advantage of the described embodiments over the prior art is that the backlight system has a higher degree of light emission uniformity.

It is to be understood, however, that even though numerous charateristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight system comprising:
a light guide plate including a plurality of incident surfaces disposed at corners thereof; a light exit surface; and a bottom surface opposite to the light exit surface; and
a plurality of point light sources for emitting light beams disposed adjacent and opposite to the incident surfaces;
wherein, the bottom surface comprises a scattering pattern having a plurality of dots thereon, and a covering rate of the scattering pattern varies such that a light distribution density of light emitted from the light guide plate is uniform.

2. The backlight system as claimed in claim 1, wherein the point light sources are light emitting diodes.

3. The backlight system as claimed in claim 1, wherein the light guide plate includes four incident surfaces disposed at opposite corners thereof.

4. The backlight system as claimed in claim 1, wherein a shape of the dots is hemispherical, cylindrical, rectangular, or cuboidal.

5. The backlight system as claimed in claim 1, wherein the bottom surface further comprises a reflective film.

6. The backlight system as claimed in claim 5, wherein the reflective film has a reflective ratio greater than 98% for wavelengths in the range of the visible spectrum.

7. A liquid crystal display comprising:
a liquid crystal panel; and
a backlight including:
a light guide plate having a plurality of incident surfaces disposed at corners of the light guide plate;
a light exit surface;
a bottom surface opposite to the light exit surface; and
a plurality of point light sources disposed adjacent and opposite to the incident surfaces for emitting light beams;
wherein, the bottom surface of the light guide plate comprises a scattering pattern having a plurality of dots thereon, and a covering rate of the scattering pattern varies such that a light distribution density of light emitted from the light guide plate is uniform.

8. The liquid crystal display as claimed in claim 9, wherein the light guide plate includes four incident surfaces disposed at opposite corners thereof.

9. The liquid crystal display as claimed in claim 9, wherein the bottom surface further comprises a reflective film.

10. A backlight system comprising:
a light guide plate defining a plurality of side faces and opposite bottom and exit faces, said side faces commonly defining a periphery of said light guide plate; and
a plurality of point light sources essentially uniformly dispersed along said periphery and commonly directing toward a center region of said light guide plate.

11. The system as claimed in claim 10, wherein said point light sources are located at corners of said light guide plate.

12. The system as claimed in claim 11, wherein an incident face is formed at each of said corners.

13. The system as claimed in claim 10, wherein each of said point light sources defines an effective angle range between two lines, and one of said two lines is aligned with one corresponding side face.

14. The system as claimed in claim 13, wherein each of said point light sources has two neighboring point light sources, and at least one of said two neighboring point light sources defines another effective angle range between another two lines wherein one of said another two lines is aligned with said same one corresponding side face so that an area beside said one corresponding side face belongs to a higher light intensity distributing area.
